(19) United States
(12) Patent Application Publication
(10) Pub. No.: US 2026/0297903 A1
(43) Pub. Date: Oct. 1, 2026

(54) WORK MACHINE AND COMMUNICATION SYSTEM FOR WORK MACHINE

(71) Applicant: KOMATSU LTD., Tokyo (JP)

(72) Inventor: Ryoichi TOGASHI, Minato-ku, Tokyo (JP)

(73) Assignee: KOMATSU LTD., Tokyo (JP)

(21) Appl. No.: 19/480,823

(22) PCT Filed: Mar. 29, 2024
(86) PCT No.: PCT/JP2024/013225

§ 371 Date: Nov. 2, 2025

(30) Foreign Application Priority Data
May 8, 2023 (JP) 2023-076885

(51) Int. Cl. E02F 9/26; E02F 3/32; H04N 7/18; H04N 23/56

(52) U.S. Cl. CPC E02F 9/261; E02F 3/32; H04N 7/183; H04N 23/56

(57) ABSTRACT

A work machine includes a vehicle body, a work implement coupled to the vehicle body, and a base station provided to the vehicle body.

### TECHNICAL FIELD

The present disclosure relates to a work machine, a communication system for a work machine, and a communication method for a work machine.

### BACKGROUND ART

In the technical field related to work machines, a work implement as disclosed in Patent Document 1 is known. In Patent Document 1, a combine harvester performs short-range communication with a smartphone, and the smartphone performs long-range communication with an external server. The work information of the combine harvester is transmitted from the smartphone to the server.

### CITATION LIST

### Patent Literature

Patent Document 1: JP 2014-216992 A

### SUMMARY OF INVENTION

### Technical Problem

The work machine may operate in a work site having a poor communication environment, such as a mountainous area.

An object of the present disclosure is to improve the communication environment of a work site.

### Solution to Problem

According to the present disclosure, there is provided a work machine including a vehicle body, a work implement coupled to the vehicle body, and a base station provided to the vehicle body.

### ADVANTAGEOUS EFFECTS OF INVENTION

According to the present disclosure, the communication environment of a work site is improved.

### BRIEF DESCRIPTION OF DRAWINGS

FIG. 1 is a view illustrating a management system for work machines according to an embodiment.

FIG. 2 is a perspective view from the front-left illustrating an excavator according to the embodiment.

FIG. 3 is a block diagram illustrating a control system for the excavator according to the embodiment.

FIG. 4 is a block diagram illustrating a vehicle-mounted controller according to the embodiment.

FIG. 5 is a view from the left illustrating a portion of the excavator according to the embodiment.

FIG. 6 is a view for describing the operation of the excavator according to the embodiment.

FIG. 7 is a view for describing the operation of the excavator according to the embodiment.

FIG. 8 is a view illustrating a camera and a light according to the embodiment.

FIG. 9 is a diagram for describing a communication method by a communication system according to the embodiment.

### DESCRIPTION OF EMBODIMENTS

Hereinafter, an embodiment according to the present disclosure will be described with reference to the drawings, but the present disclosure is not limited to the embodiment. Components of the embodiments described below can be combined as appropriate. Some components are not used in some cases.

### Overview of Management System

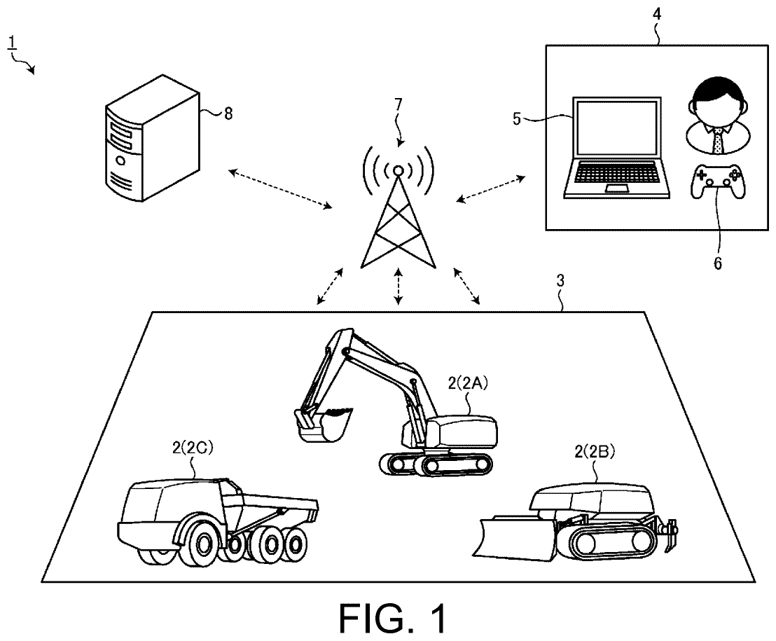

FIG. 1 is a view illustrating a management system 1 of work machines 2 according to an embodiment. The management system 1 manages the work machines 2 operating at a work site 3. In the embodiment, each of the work machines 2 is an electric work machine that uses a battery and an electric motor as a power source. At the work site 3, a plurality of the work machines 2 are present. In the example illustrated in FIG. 1, the work machines 2 present at the work site 3 include an excavator 2A, a bulldozer 2B, and a dump truck 2C.

In the embodiment, operators do not board the work machines 2. The work machines 2 are remotely operated. A remote operation room 4 is installed outside the work machines 2. The remote operation room 4 is installed at a remote location of the work site 3. An information terminal 5 and a remote operation device 6 for remotely operating the work machines 2 are each arranged in the remote operation room 4. Each of the information terminal 5 and the remote operation device 6 is present outside the work machines 2. The information terminal 5 includes a computer system disposed in the remote operation room 4.

The remote operation device 6 is operated by an operator in the remote operation room 4. The remote operation device 6 is operated by the operator, thereby generating operation signals for remotely operating the work machines 2. The operation signals generated in the remote operation device 6 are input to the information terminal 5. The information terminal 5 generates a remote operation command on the basis of the operation signals from the remote operation device 6. The information terminal 5 transmits the remote operation command to the work machines 2 via a communication system 7.

The work machines 2 operate on the basis of the remote operation command transmitted from the information terminal 5 present outside the work machines 2. At least one of the work machines 2 or the work site 3 is provided with a camera that acquires image data of the work site 3. The image data of the work site 3 is transmitted to the information terminal 5 via the communication system 7 and displayed on a display device of the information terminal 5. The operator can operate the remote operation device 6 while checking the image data of the work site 3.

The communication system 7 includes a mobile phone communication network. Note that the communication system 7 may include a satellite communication network. The communication system 7 may include a public communication line or may include a dedicated communication line. Note that the communication system 7 may include the Internet or may include a local area network.

The management system 1 includes a management server 8. The management server 8 includes a computer system. The management server 8 can communicate with the work machines 2 via the communication system 7. The management server 8 collects operation data of the work machines 2. The management server 8 outputs control commands to the work machines 2.

### Work Machine

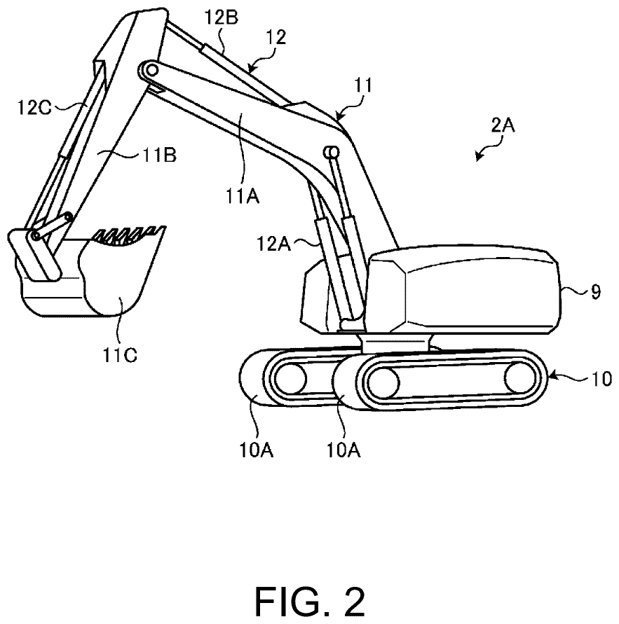

FIG. 2 is a perspective view from the front-left illustrating an excavator 2A according to the embodiment. The excavator 2A includes a revolving body 9, a traveling body 10, a work implement 11, and a work implement cylinder 12.

The revolving body 9 is the vehicle body of the excavator 2A. The traveling body 10 is the traveling device of the excavator 2A. The traveling body 10 supports the revolving body 9. The revolving body 9 is supported by the traveling body 10 in a revolvable manner. The revolving body 9 is disposed above the traveling body 10. The traveling body 10 travels while supporting the revolving body 9. The traveling body 10 includes a pair of crawler tracks 10A. Rotation of the crawler tracks 10A causes the excavator 2A to travel.

The work implement 11 is coupled to a front portion of the revolving body 9. The work implement 11 includes a boom 11A coupled to the front portion of the revolving body 9, an arm 11B coupled to the boom 11A, and a bucket 11C coupled to the arm 11B. The work implement cylinder 12 includes a boom cylinder 12A that operates the boom 11A, an arm cylinder 12B that operates the arm 11B, and a bucket cylinder 12C that operates the bucket 11C.

### Control System

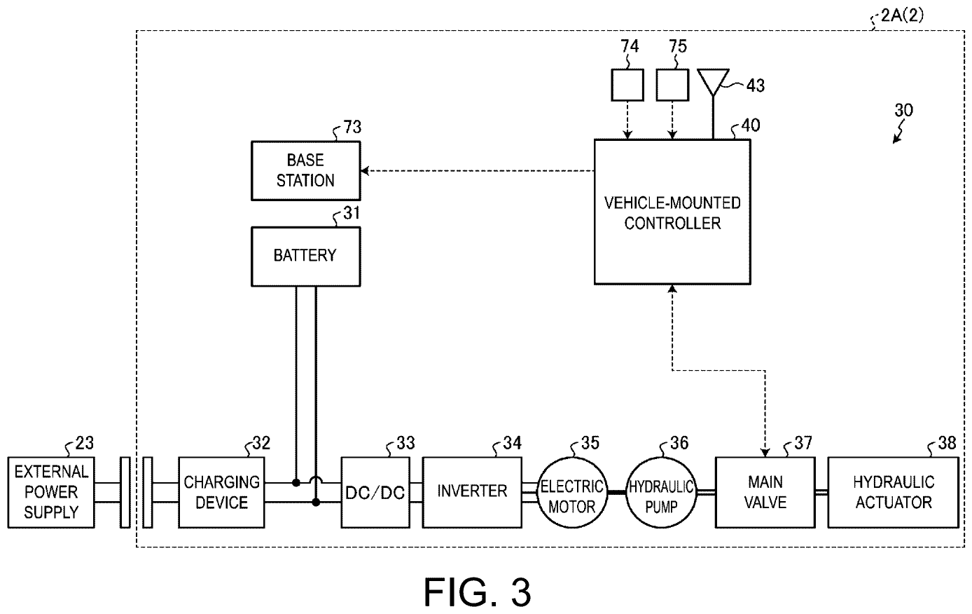

FIG. 3 is a block diagram illustrating a control system 30 of the excavator 2A according to the embodiment. The excavator 2A includes the control system 30. The control system 30 includes a battery 31, a charging device 32, a DC/DC converter 33, an inverter 34, an electric motor 35, a hydraulic pump 36, a main valve 37, a hydraulic actuator 38, a base station 73, a camera 74, a light 75, a vehicle-mounted controller 40, and a communicator 43.

The battery 31 is a built-in battery mounted on the excavator 2A. The battery 31 includes a secondary battery. In the embodiment, the battery 31 includes a lithium ion battery (LiB).

The charging device 32 is connected to an external power supply 23 provided outside the excavator 2A. The external power supply 23 includes a commercial power supply. The commercial power supply includes a charging station. The charging device 32 includes an AC/DC converter. The charging device 32 charges the battery 31 with electric power supplied from the external power supply 23.

The DC/DC converter 33 boosts a voltage from the battery 31. The DC/DC converter 33 supplies direct current from the battery 31 to the inverter 34.

The inverter 34 converts the direct current from the DC/DC converter 33 into a three-phase alternating current and supplies the three-phase alternating current to the electric motor 35. The electric motor 35 is driven by the three-phase alternating current supplied from the inverter 34.

The electric motor 35 is a power source of the excavator 2A. The electric motor 35 is driven by electric power from the battery 31.

The hydraulic pump 36 is driven by the electric motor 35. The hydraulic pump 36 discharges hydraulic oil. The hydraulic oil discharged from the hydraulic pump 36 is supplied to the hydraulic actuator 38 via a main valve 37. The hydraulic actuator 38 of the excavator 2A includes the work implement cylinder 12.

Note that, an electric actuator may be provided to the excavator 2A instead of the hydraulic pump 36 and the hydraulic actuator 38. The work implement cylinder 12 may be an electric cylinder. When an electric actuator is provided to the excavator 2A instead of the hydraulic actuator 38, the hydraulic pump 36 and the main valve 37 are omitted.

The base station 73 is a base station of a mobile phone communication network. The base station 73 may be a base station of the fourth generation mobile communication system (4G), a base station of the fifth generation mobile communication system (5G), or a base station of the sixth generation mobile communication system (6G). The communication system 7 includes the base station 73. The base station 73 relays communication between the wireless communication terminal and another base station or exchange station. The base station 73 is provided to the revolving body 9. The base station 73 is a vehicle-mounted base station. The excavator 2A including the base station 73 functions as a mobile base station.

The camera 74 captures an image of the surroundings of the excavator 2A. The camera 74 may be a 4K camera capable of capturing an image at 4K resolution, or may be an infrared camera. The image captured by the camera 74 may be a still image or a moving image (video image). The camera 74 may capture an image while automatically tracking a moving object in the surroundings of the excavator 2A. For example, when the moving object is a person and a human sensor (infrared sensor) is provided to at least a portion of the excavator 2A, the camera 74 may capture an image of the person in the surroundings of the excavator 2A while automatically tracking the person on the basis of the detection data of the human sensor.

The light 75 is attached to the camera 74. The light 75 illuminates the surroundings of the excavator 2A with illumination light. The light 75 may illuminate a moving object in the surroundings of the excavator 2A while automatically tracking the moving object. For example, when the moving object is a person and a human sensor (infrared sensor) is provided to at least a portion of the excavator 2A, the light 75 may illuminate while automatically tracking the person in the surroundings of the excavator 2A on the basis of the detection data of the human sensor.

The vehicle-mounted controller 40 includes a computer system. The communicator 43 is coupled to the vehicle-mounted controller 40. The communicator 43 performs wireless communication with the management server 8.

### Vehicle-Mounted Controller

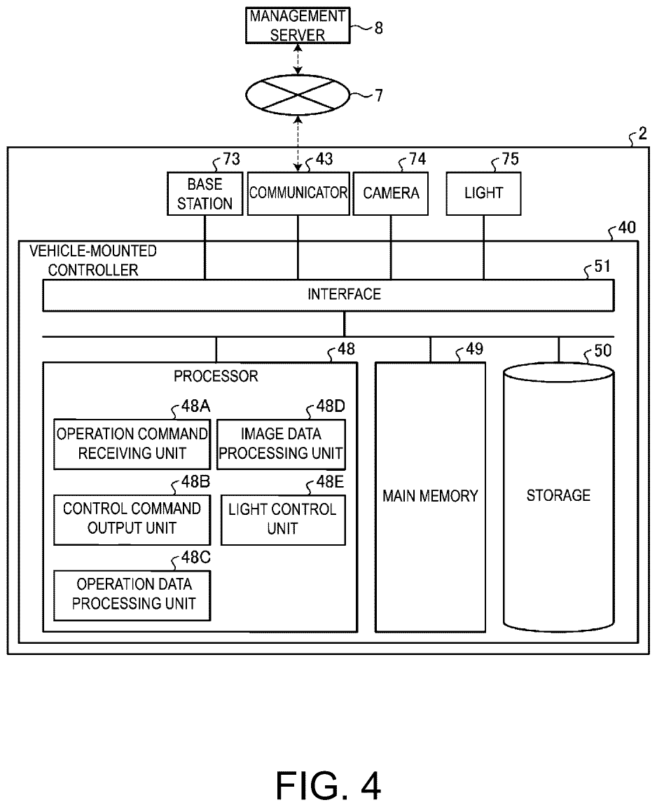

FIG. 4 is a block diagram illustrating the vehicle-mounted controller 40 according to the embodiment. Each of the management server 8 and the vehicle-mounted controller 40 includes a computer system. The vehicle-mounted controller 40 includes a processor 48 such as a central processing unit (CPU), a main memory 49 including a non-volatile memory such as a read only memory (ROM) and a volatile memory such as a random access memory (RAM), a storage 50, and an interface 51 including an input-output circuit. Functions of the vehicle-mounted controller 40 are stored in the storage 50 as a computer program. The processor 48 reads out the computer program from the storage 50, deploys the computer program into the main memory 49, and executes processing in accordance with the computer program. Note that the computer program may be distributed to the management server 8 via a network.

Similarly, the management server 8 includes a processor, a main memory, a storage, and an interface.

The processor 48 includes an operation command receiving unit 48A, a control command output unit 48B, an operation data processing unit 48C, an image data processing unit 48D, and a light control unit 48E.

The operation command receiving unit 48A receives a remote operation command transmitted from the information terminal 5. The control command output unit 48B outputs a control command for controlling the excavator 2A on the basis of the remote operation command received by the operation command receiving unit 48A. The control command output unit 48B outputs a control command for causing at least one of the revolving body 9, the traveling body 10, and the work implement 11 to operate on the basis of the remote operation command received by the operation command receiving unit 48A.

The operation data processing unit 48C collects operation data of the excavator 2A. The operation data collected by the operation data processing unit 48C is stored in the storage 50. The operation data processing unit 48C transmits the operation data of the excavator 2A stored in the storage 50 to the management server 8.

The operation data of the excavator 2A includes an operation duration of the excavator 2A and an operating location of the excavator 2A. The operation duration of the excavator 2A includes the operation duration of the electric motor 35 of the excavator 2A. The operation data of the excavator 2A includes the amount of electric power consumed by the electric motor 35. The operation data of the excavator 2A includes abnormality data of the excavator 2A. The abnormality data of the excavator 2A includes abnormality content, abnormality position, and abnormality occurrence time of the excavator 2A. The excavator 2A is provided with a plurality of sensors that detect the operation data. Examples of the sensors include a motor sensor that detects the operation duration of the electric motor 35 and a location sensor that detects the operating location of the excavator 2A. The location sensor may include a global navigation satellite system (GNSS) receiver that detects the absolute location of the excavator 2A by using the GNSS. The operation data processing unit 48C can collect the operation data of the excavator 2A by acquiring the detection data of the sensor.

The image data processing unit 48D acquires image data of the surroundings of the revolving body 9 captured by the camera 74. The image data acquired by the image data processing unit 48D is stored in the storage 50. The image data processing unit 48D transmits the image data of the surroundings of the excavator 2A stored in the storage 50 to the management server 8.

The light control unit 48E controls the light 75. The light control unit 48E determines the illumination conditions of the light 75 including the illumination start time, the illumination duration, and the illumination end time of the light 75. The light control unit 48E controls the light 75 on the basis of the determined illumination conditions. In addition, when the moving object in the surroundings of the excavator 2A is a person and a human sensor (infrared sensor) is provided to at least a portion of the excavator 2A, the light control unit 48E controls the light 75 so that the person in the surroundings of the excavator 2A is subjected to automatic tracking lighting on the basis of the detection data of the human sensor.

### Base Station

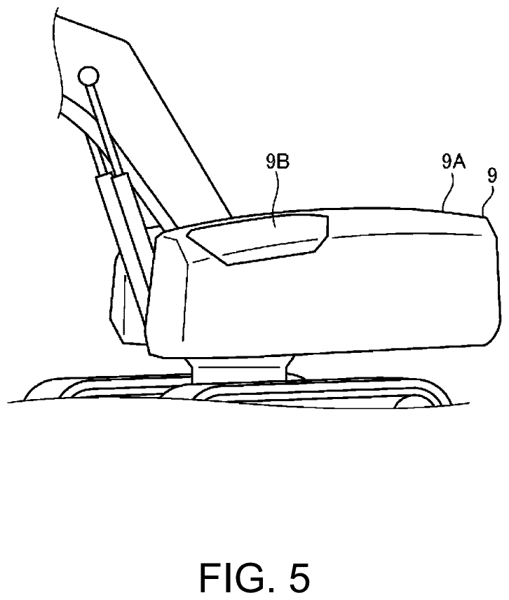

FIG. 5 is a view from the left illustrating a portion of the excavator 2A according to the embodiment. As illustrated in FIG. 5, the revolving body 9 includes a vehicle body frame 9A and a top cover 9B disposed on an upper portion of the vehicle body frame 9A. A work implement 11 is coupled to a front portion of the vehicle body frame 9A. The top cover 9B is disposed so as to cover an opening provided to an upper portion of the vehicle body frame 9A. The top cover 9B is opened and closed by the operation of the actuator.

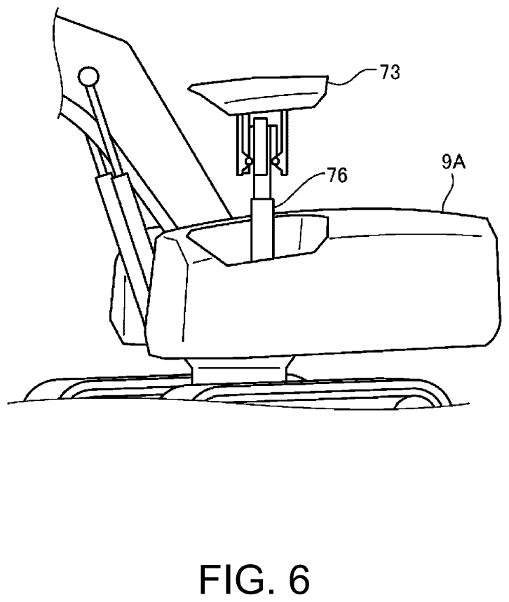

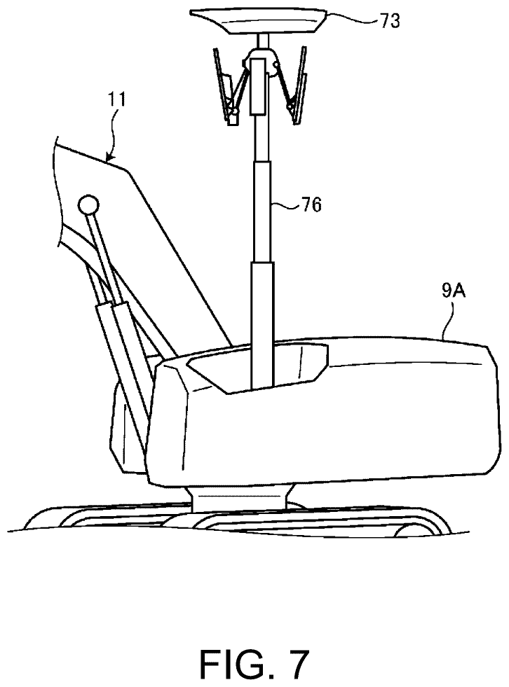

Each of FIG. 6 and FIG. 7 is a diagram for describing the operation of the excavator 2A according to the embodiment. When the base station 73 is not used, the base station 73 is housed inside the revolving body 9. In a state in which the base station 73 is housed inside the revolving body 9, the top cover 9B is closed. As illustrated in FIG. 6, when the base station 73 is used, the control command output unit 48B opens the top cover 9B. After opening the top cover 9B, the control command output unit 48B moves the base station 73 to the outside of the revolving body 9. The control command output unit 48B disposes the base station 73 above the revolving body 9.

That is, in the embodiment, the base station 73 (an antenna of the base station 73) changes between a state of being housed inside the revolving body 9 and a state of being disposed above the revolving body 9.

The excavator 2A includes a pole 76 extending upward from the revolving body 9. The base station 73 (the antenna of the base station 73) is disposed at an upper end portion of the pole 76. The pole 76 stretches and contracts in an up-down direction. The pole 76 has a telescopic structure and can stretch and contract. The pole 76 stretches and contracts such that the base station 73 changes between the state of being housed inside the revolving body 9 and the state of being disposed above the revolving body 9. As illustrated in FIG. 7, when the base station 73 is used, the control command output unit 48B stretches the pole 76 to the maximum.

In the embodiment, the central axis of the pole 76 and a revolution axis of the revolving body 9 coincide with each other. The central axis of the pole 76 extends in the up-down direction. The revolving body 9 revolves around the revolution axis. The revolution axis of the revolving body 9 extends in the up-down direction. Since the central axis of the pole 76 and the revolution axis of the revolving body 9 coincide with each other, the excavator 2A can smoothly perform work in a state in which the pole 76 is stretched. In the embodiment, the excavator 2A can perform work using the work implement 11 in a state in which the base station 73 is usable.

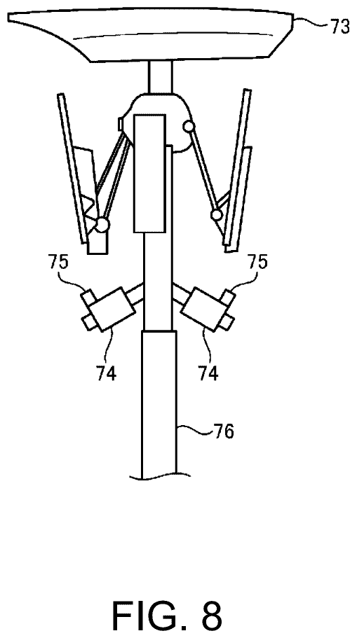

Crime Prevention System FIG. 8 is a diagram illustrating the camera 74 and the light 75 according to the embodiment. As illustrated in FIG. 8, the camera 74 may be attached to the pole 76. In the example illustrated in FIG. 8, the camera 74 is attached to the pole 76 below the base station 73. As illustrated in FIG. 8, the plurality of cameras 74 may be attached to the pole 76. As illustrated in FIG. 8, the light 75 may be attached to the camera 74. The light 75 may be attached near the camera 74. The light 75 may be attached to the pole 76 near the camera 74, for example.

The camera 74 and the light 75 function as a crime prevention system for the work site 3. The camera 74 functions as a crime prevention camera. The light 75 functions as a crime prevention light. The excavator 2A is kept at the work site 3 during a period in which the work at the work site 3 is not performed. Examples of the period in which the work at the work site 3 is not performed include nighttime and holidays. In the period in which no work is performed at the work site 3, neither a worker nor an operator of the work machine 2 is present at the work site 3.

In the period in which no work is performed at the work site 3, the camera 74 captures images in the surroundings of the excavator 2A. For example, when a suspicious person is present in the surroundings of the excavator 2A, the camera 74 captures images while automatically tracking the suspicious person. The image data of the surroundings of the excavator 2A captured by the camera 74 is transmitted to the management server 8. The image data of the surroundings of the excavator 2A is displayed on a display coupled to the management server 8. The image data displayed on the display is checked by, for example, a security guard. When a suspicious person is present in the surroundings of the excavator 2A, the security guard can confirm the presence of the suspicious person. Thus, the crime at the work site 3 can be prevented.

Note that the image data processing unit 48D may identify a suspicious person from the images captured by the camera 74 by an image-recognition technique using artificial intelligence (AI) or the like, for example. The image data processing unit 48D may transmit the image data to the management server 8 only when a suspicious person is detected. Upon detecting a suspicious person, the image data processing unit 48D may immediately transmit a caution message to the management server 8. Upon detecting a suspicious person, the image data processing unit 48D may transmit a caution message to an administrative agency such as the police. Note that, when the image captured by the camera 74 is a moving image (video image), both the still image and the moving image in which a suspicious person is captured may be transmitted to the management server 8 or the administrative agency.

During a period in which a work at the work site 3 is not being performed, the light 75 illuminates the surroundings of the excavator 2A with illumination light. For example, when a suspicious person is present in the surroundings of the excavator 2A, the light 75 illuminates while automatically tracking the suspicious person. Thus, the crime at the work site 3 can be prevented.

### Communication Method

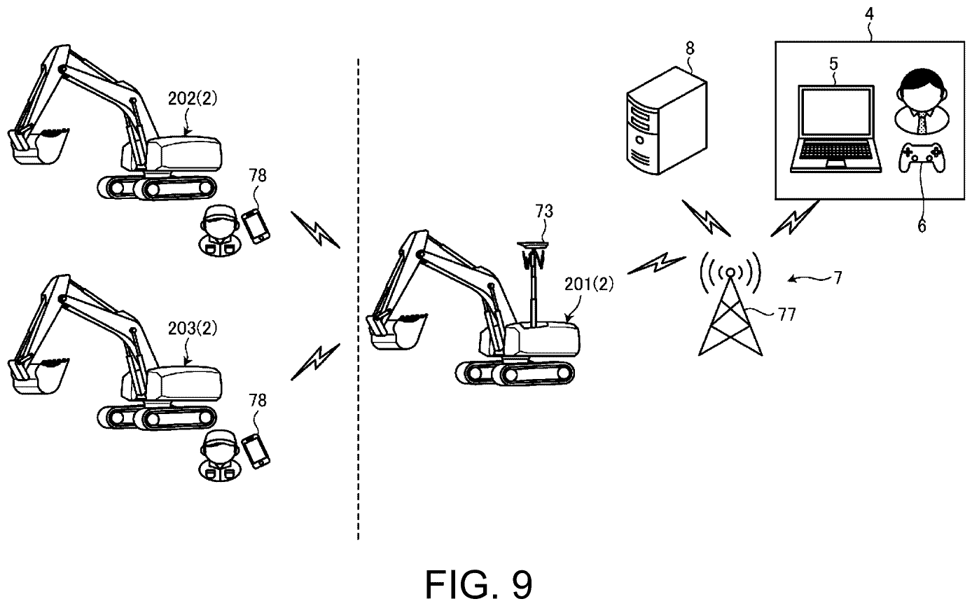

FIG. 9 is a diagram for describing a communication method by the communication system 7 according to the embodiment. The communication system 7 includes a fixed base station 77, and the base station 73 (mobile base station) provided to the first excavator 201.

The second excavator 202 and the third excavator 203 may operate in the work site 3 having a poor communication environment, such as a mountainous area. Each of the second excavator 202 and the third excavator 203 does not have the base station 73. When the second excavator 202 and the third excavator 203 operate outside the communication range of the fixed base station 77, each of the second excavator 202 and the third excavator 203 cannot transmit the operation data to the management server 8. The information terminal 5 cannot transmit a remote operation command to each of the second excavator 202 and the third excavator 203.

In the embodiment, the first excavator 201 including the base station 73 is disposed at a location where communication can be established between the management server 8 and each of the second excavator 202 and the third excavator 203. The first excavator 201 including the base station 73 is disposed at a location where communication can be established between the information terminal 5 and each of the second excavator 202 and the third excavator 203. The first excavator 201 including the base station 73 may be disposed at a location where communication between the second excavator 202 and the fixed base station 77 can be relayed, for example. The first excavator 201 may be disposed at the work site 3 where the second excavator 202 is performing work. The first excavator 201 may perform work together with the second excavator 202 at the work site 3 where the second excavator 202 is performing work.

When the first excavator 201 including the base station 73 is disposed at a location where the first excavator 201 can communicate with each of the second excavator 202 and the management server 8, the operation data processing unit 48C of the second excavator 202 can transmit the operation data of the second excavator 202 to the management server 8 via the base station 73 provided to the first excavator 201. The operation command receiving unit 48A of the second excavator 202 can receive the remote operation command from the information terminal 5 via the base station 73 provided to the first excavator 201. The control command output unit 48B of the second excavator 202 can output a control command for causing the second excavator 202 to operate on the basis of the remote operation command.

Similarly, when the first excavator 201 including the base station 73 is disposed at a location where the first excavator 201 can communicate with each of the third excavator 203 and the management server 8, the vehicle-mounted controller 40 of the third excavator 203 can transmit the operation data of the third excavator 203 to the management server 8 via the base station 73. The vehicle-mounted controller 40 of the third excavator 203 can output a control command for causing the third excavator 203 to operate on the basis of the remote operation command received via the base station 73.

In a case that a worker or an operator of the excavator 2A (202 and 203) at the work site 3 carries a mobile terminal 78, when the first excavator 201 including the base station 73 is disposed at a location where the first excavator 201 can communicate with the mobile terminal 78, the worker or the operator can use the mobile terminal 78. When the first excavator 201 including the base station 73 is disposed at a location where the first excavator 201 can communicate with each of the mobile terminal 78 and the management server 8, the mobile terminal 78 can communicate with the management server 8 via the base station 73.

For example, when the vehicle-mounted controller 40 of the second excavator 202 cannot communicate with the base station 73, the mobile terminal 78 may receive the operation data of the second excavator 202 from the vehicle-mounted controller 40 of the second excavator 202. The mobile terminal 78 can receive the operation data of the second excavator 202 from the vehicle-mounted controller 40 of the second excavator 202 by a communication method different from the communication method of the base station 73 of the mobile phone communication network. The mobile terminal 78 may receive the operation data of the second excavator 202 from the vehicle-mounted controller 40 of the second excavator 202 with a wireless local area network (LAN) or a wireless personal area network (PAN), for example. An example of the wireless LAN is Wifi (registered trademark). An example of the wireless PAN is Bluetooth (registered trademark). After receiving the operation data of the second excavator 202, the mobile terminal 78 may transmit the operation data of the second excavator 202 to the management server 8 via the base station 73. The same applies to the third excavator 203.

### Effects

As described above, according to the embodiment, the base station 73 is provided to the excavator 2A, and the excavator 2A functions as a mobile base station, whereby the communication environment of the work site 3 is improved. As described with reference to FIG. 9, even in a case that the work site 3 where the second excavator 202 operates is outside the communication range of the fixed base station 77, when the first excavator 201 including the base station 73 is disposed at the work site 3 of the second excavator 202, the vehicle-mounted controller 40 of the second excavator 202 can transmit the operation data of the second excavator 202 to the management server 8 via the base station 73.

In the embodiment, a crime prevention system including at least one of the camera 74 and the light 75 is provided to the excavator 2A. Thus, in a period in which the work at the work site 3 is not performed, the crime prevention system for the excavator 2A kept at the work site 3 monitors the surroundings of the excavator 2A, whereby a crime at the work site 3 can be prevented.

### Other Embodiments

In the above-described embodiment, data associated with the base station 73 such as the amount of data communication of the base station 73 may be stored in the storage 50. The data associated with the base station 73 may be transmitted from the vehicle-mounted controller 40 of the first excavator 201 to the management server 8. The data associated with the base station 73 may be transmitted from the vehicle-mounted controller 40 of the first excavator 201 to a communication service provider such as an Internet service.

In the above-described embodiment, the pole 76 can stretch and contract, and when the base station 73 is used, the pole 76 is stretched so that the antenna of the base station 73 is disposed above the revolving body 9. The base station 73 may be used in a state in which the antenna of the base station 73 is housed inside the revolving body 9.

In the above-described embodiment, the pole 76 may not be stretched or contracted. The pole 76 may be in a stretched state so that the antenna of the base station 73 is constantly disposed above the revolving body 9. The antenna of the base station 73 may be constantly disposed above the revolving body 9 by fixing the pole 76 that does not stretch and contract to the revolving body 9, disposing the upper end portion of the pole 76 above the revolving body 9, and disposing the antenna of the base station 73 at the upper end portion of the pole 76. The base station 73 may be constantly usable. A communication device capable of using the base station 73 may be constantly capable of communicating by using the base station 73. For example, each of the second excavator 202, the third excavator 203, and the mobile terminal 78 described above may be constantly capable of communicating with the management server 8 or the information terminal 5 by using the base station 73.

In the above-described embodiment, the work machine 2 provided with the base station 73 may be a bulldozer 2B or a dump truck 2C.

### REFERENCE SIGNS LIST

1 Management system, 2 Work machine, 2A Excavator, 2B Bulldozer, 2C Dump truck, 3 Work site, 4 Remote operation room, 5 Information terminal, 6 Remote operation device, 7 Communication system, 8 Management server, 9 Revolving body, 9A Vehicle body frame, 9B Top cover, 10 Traveling body, 10A Crawler track, 11 Work implement, 11A Boom, 11B Arm, 11C Bucket, 12 Work implement cylinder, 12A Boom cylinder, 12B Arm cylinder, 12C Bucket cylinder, 23 External power supply, 30 Control system, 31 Battery, 32 Charging device, 33 DC/DC converter, 34 Inverter, 35 Electric motor, 36 Hydraulic pump, 37 Main valve, 38 Hydraulic actuator, 40 Vehicle-mounted controller, 43 Communicator, 48 Processor, 48A Operation command receiving unit, 48B Control command output unit, 48C Operation data processing unit, 48D Image data processing unit, 48E Light control unit, 49 Main memory, 50 Storage, 51 Interface, 73 Base station, 74 Camera, 75 Light, 76 Pole, 77 Fixed base station, 78 Mobile terminal, 201 First excavator, 202 Second excavator, 203 Third excavator.

1. A work machine comprising:
a vehicle body;
a work implement coupled to the vehicle body; and
a base station provided to the vehicle body.

2. The work machine according to claim 1, comprising:
a pole extending upward from the vehicle body, wherein
the base station is disposed at an upper end portion of the pole.

3. The work machine according to claim 2, wherein
the pole stretches and contracts in an up-down direction, and
the pole stretches and contracts to change between a state in which the base station is housed inside the vehicle body and a state in which the base station is disposed above the vehicle body.

4. The work machine according to claim 2, comprising:
a traveling body, wherein
the vehicle body is a revolving body supported by the traveling body in a revolvable manner, and
a central axis of the pole and a revolution axis of the revolving body coincide with each other.

5. The work machine according to claim 1, wherein
the base station is constantly usable, and
a communication device capable of using the base station communicates constantly by using the base station.

6. The work machine according to claim 2, comprising:
a camera attached to the pole.

7. The work machine according to claim 6, comprising:
a processor, wherein
the processor transmits image data of a surrounding of the vehicle body captured by the camera to a server.

8. The work machine according to claim 6, wherein
the camera automatically tracks a moving object in a surrounding of the vehicle body.

9. The work machine according to claim 6, comprising:
a light attached near the camera.

10. A work machine comprising:
a vehicle body;
a work implement coupled to the vehicle body;
a pole extending upward from the vehicle body;
a camera attached to the pole; and
a processor configured to transmit image data of a surrounding of the vehicle body captured by the camera to a server.

11. The work machine according to claim 10, wherein
the camera automatically tracks a moving object in the surrounding of the vehicle body.

12. The work machine according to claim 10, comprising:
a light attached near the camera.

13. A communication system for a work machine, comprising:
a base station provided to a first work machine; and
a vehicle-mounted controller provided to a second work machine and configured to transmit operation data of the second work machine to a server via the base station.

14. The communication system for a work machine according to claim 13, wherein
the vehicle-mounted controller outputs, on the basis of a remote operation command received via the base station, a control command causing the second work machine to operate.

15. The communication system for a work machine according to claim 13, comprising:
a mobile terminal configured to receive the operation data of the second work machine, wherein
the mobile terminal transmits the operation data of the second work machine to the server.

16. (canceled)
